(19) United States
(12) Patent Application Publication
(10) Pub. No.: US 2012/0005946 A1
(43) Pub. Date: Jan. 12, 2012

(54) ECO-FRIENDLY, LEAD FREE, REPLACEABLE JIG HEAD SYSTEM

(76) Inventor: Gary Bennis, Eau Claire, WI (US)

(21) Appl. No.: 12/782,625

(22) Filed: May 18, 2010

Related U.S. Application Data
(60) Provisional application No. 61/179,337, filed on May 18, 2009.

(51) Int. Cl. A01K 83/00; A01K 97/00; A01K 85/00

(52) U.S. Cl. 43/42.53; 43/43.16; 43/44.87

(57) ABSTRACT

The invention generally relates to a modular fishing hook accessory mounting system for removably mounting a fishing accessory on a hook. The system includes a hook, a modular mounting member and a fishing accessory. The hook has a shank portion and an eye shank portion, the eye shank portion being located at one end of the shank portion. The modular mounting member is mounted on the hook for removably receiving a fishing accessory. The fishing accessory is removably mounted on the modular mounting member, the fishing accessory having a recess formed therein for slidably receiving at least a portion of a retaining member for retaining the retaining member and fishing accessory to the mounting member. The fishing accessory may be a jig head that is substantially lead-free, such as being made from a steel that has been powdered, pressed and sintered. Of course, the modular fishing hook accessory mounting system will work with lead jig head that is modified to be removable.

### TECHNICAL FIELD

The field of the invention generally relates to a replaceable jig head system. One particular aspect is that the traditional lead jig head is replaced with a substantially lead-free jig head that is designed to be removably attached to a mounting member.

### BACKGROUND

Anglers traditionally use a number of lead items in fishing for a number of reasons, including cost, ease of manufacturability, high density and, unfortunately, an aversion to change from that which has traditionally been used. The presence and use of lead is generally recognized as being undesirable in the nation's waterways. The fishing weight is one fishing article that traditionally uses lead. Another fishing article that relies on lead is the fishing jig or jig head. U.S. Pat. No. 5,081,786 is directed to a method of constructing fishing lures that includes casting a mass of melted alloy material of about 90%-94% tin, and about 4%-8% antimony. The '786 patent describes this fishing lure as being substantially lead free.

A fishing jig is used by an angler to stimulate or attract fish to bite the jig hook. To attract the fish, fishing jigs vary by jig head color, shape, size, buoyancy and weight in an effort to imitate or emphasize attached live or artificial bait. To improve performance or attractiveness, the angler can vary the fishing jig by using one or more of fishing accessories, such as skirts, rattlers, weed guards, stinger hooks, flashers, spoons and other items. Some anglers use the hook on the fishing jig to attach various minnows, leaches, worms, grubs and other salt or fresh water live or natural baits.

Most anglers know that there is variability in fish behavior from day-to-day. For example, a fish population that aggressively hits a black ¼ ounce lead jig tipped with a leach on one day might ignore that offering and lightly tap a red ⅛ ounce skirted lead jig on the next day. Changing fish appetites and levels of aggression can be attributed to altered environmental conditions such as barometric pressure, light, wind, moon phase, seasons and other variables. Localized influences, such as water clarity, water temperature, salinity, acidity, depth, natural prey availability, population density and other variables, also affect each fish population's affinity for various jig combinations.

Because these factors can change over a year, and even over short time spans of minutes or hours, predicting the response of fish to these changes is difficult and most, if not all, anglers resort to trial and error to determine which jig combination is effective for a particular outing. As anglers endeavor to catch fish, their ability to stay in sync with the preferences of their prey will dictate the degree of their success.

To address this need of the angler, U.S. Pat. No. 6,898,894 discloses a fishing jig system with an interchangeable jig head for permitting a variety of jig heads with different configurations and functions to be used with a single jig hook and avoid having to remove the jig hook from a fishing line to reconfigure the fishing jig. The jig system includes a hook having a shank portion and an eye portion, with the shank portion and the eye portion meeting at a juncture. A modular mounting member is mounted on the hook at the juncture for removably receiving a jig head. A jig head is removably mounted on the modular mounting member, and has a recess formed therein for slidably receiving the modular mounting member such that the accessory may be removed and replaced without removing the jig hook from the fishing line. The '894 patent notes that known fishing jigs have been composed of a jig head of various materials, such as colored lead or a buoyant material. The '894 patent also notes that the jig heads have been molded directly and inseparably to a jig hook.

Various patents disclose modifications to fishing jigs. For example, U.S. Pat. No. 6,233,863 discloses a fishing lure and kit that includes a fishing hook secured to a fishing line and a trailing member, such as a fishing jig skirt. A capture structure, such as a curved wire, is provided on the hook for removably coupling the trailing member to the hook. An elastic sleeve is shaped to constrict about the hook and capture structure to maintain the coupling between the hook and trailing member.

U.S. Pat. No. 5,899,015 is directed to a fishing jig that includes a lead jig head and a removable skirt. The eye of the hook is recessed into the lead jig head to protect the line. U.S. Pat. No. 5,680,726 describes a fishing jig in which a lead weight can be removably replaced onto a “safety pin” apparatus attached to a fishing hook. This configuration is shown in FIG. 4 of the '726 patent.

U.S. Pat. No. 5,537,775 is directed to a fishing jig in which a lead jig head can be removably attached to a fishing hook. The removable attachment results from the hook not terminating at the eye but instead have a portion that forms an extension that is generally parallel to the shank but with a bias away from the shank of the hook. The lead jig head is threaded over the barb of the hook and the extension is fed through the jig head.

In use, fishing jigs are tied directly to fishing line using a knot that is intended not to come untied. Because most fishing jigs have a permanent color, shape, size, buoyancy and weight, in order to try different combinations of color, shape, buoyancy and weight in the jig used, an angler must change the entire fishing jig that has been tied to the fishing line and tie on a new fishing jig. A similar lack of options exists for most skirts, rattlers, weed guards, stinger hooks, flashers, spoons and other jig modifications and fishing accessories—in order to change between these modifications, the entire fishing jig needs to be changed and/or the bait removed from the hook of the jig.

Changing between jigs requires cutting the fishing line, removing the live or artificial bait from the old jig, possibly cleaning paint out of the eyelet of a new jig, threading the eyelet of the new jig, re-tying the line to the new jig and reattaching the old live or artificial bait. When the live bait is damaged from the removal process, or from environmental factors such as sunlight or dry air, new bait may need to be retrieved and attached. All of these steps take time and may not be the easiest to accomplish depending upon weather (e.g., cold, raining, windy, etc.) or water (e.g., choppy waves rocking the boat, etc.) conditions.

### SUMMARY

In one general aspect, there is provided a modular fishing hook accessory mounting system for removably mounting a fishing accessory on a hook. The system includes a hook, a modular mounting member and a fishing accessory. The hook has a shank portion and an eye shank portion, the eye shank portion being located at one end of the shank portion. The modular mounting member is mounted on the hook for removably receiving a fishing accessory. The fishing accessory is removably mounted on the modular mounting member, the fishing accessory having a recess formed therein for slidably receiving at least a portion of a retaining member for retaining the retaining member and fishing accessory to the mounting member.

Embodiments of the modular fishing hook accessory mounting system may include one or more of the following features. For example, the fishing accessory may be a jig head. The jig head may be lead-free or substantially lead-free. The jig head may be steel. The steel may be a sintered steel. The jig head may be made of one or more of tungsten, nickel, brass, lead, and a composite of one or more metals.

The retaining member may include a retaining portion for mating with a retaining portion of the mounting member to form a retaining system for removably securing the retaining member to the mounting member. The retaining system may include at least one ridge extending from the retaining member and at least one groove extending into the mounting member for receiving the ridge. Alternatively, the retaining system may include at least one groove extending into the retaining member and at least one ridge extending from the mounting member for being received into the groove.

The shank portion and the eye shank portion of the hook may meet at a juncture, the modular mounting member being located at the juncture of the hook.

The retaining member may be a grommet having a channel through at least a portion of its length. The grommet may have at least one aligning portion configured to align the grommet with the fishing accessory. The grommet may be a longitudinal slot for receiving the eye shank portion.

The modular fishing hook accessory mounting system may further include a retaining system for retaining a second fishing accessory to the modular fishing hook accessory mounting system. The retaining system may include an elastic ring member on the second fishing accessory and a groove or ridge for mating with the elastic ring member. The groove or ridge may be placed on the mounting member, the retaining member, and/or the fishing accessory.

In another general aspect there is provided a lead-free fishing jig for removably mounting a jig head on a hook. The system includes a hook, a modular mounting member, and a jig head. The hook includes a shank portion and an eye shank portion, the eye shank portion being located at one end of the shank portion. The modular mounting member is mounted on the hook for removably receiving the jig head. The jig head is removably mounted on the modular mounting member.

Embodiments of the lead-free fishing jig may include one or more of the following features as well as those described above. For example, the jig head may have a recess formed therein for slidably receiving at least a portion of a retaining member for retaining the retaining member and jig head to the mounting member. The jig head may include one or more of steel, tungsten, nickel, brass, lead, and a composite of one or more metals. The jig head may be a steel and the steel may be a sintered steel.

In another general aspect, there is provided a method of forming a jig head for a fishing jig. The method includes providing a powdered steel, pressing the steel, and sintering the steel.

Embodiments of the method may include one or more of the following features or those described above. For example, the steel may be substantially free of lead.

In another general aspect, a removable jig head includes a jig head having a channel there through and a retaining member for being slidably received within the channel.

Embodiments of the removable jig head may include one or more of the following features or those described above. For example, the retaining member may be a grommet.

The details of various embodiments of the invention are set forth in the accompanying drawings and the description below. Other features and advantages of the invention will be apparent from the description, the drawings, and the claims.

### DESCRIPTION OF THE DRAWINGS

FIG. 1 is a cross-section side view of a fishing jig having a removable jig head.

FIG. 2 is an enlarged cross-sectional side view of a retaining means that retains the removable jig head to the fishing jig.

FIG. 3 is a side view showing hidden lines for a grommet used with the jig head.

FIG. 4 is a top view of the grommet of FIG. 3.

FIG. 5 is a front view showing hidden lines for the grommet of FIG. 3.

FIG. 6 is a cross-sectional side view of the grommet of FIG. 3.

FIG. 6A is a bottom view of the fishing jig showing a D-Shaped grommet

FIG. 7 is a cross-sectional side view of the removable jig head.

FIG. 8 is a top view of the removable jig head of FIG. 7.

FIG. 9 is a perspective view showing the insertion of the grommet into the jig head to form a jig head-grommet assembly.

FIGS. 10 and 11 are front and cross-sectional side views of the jig head-grommet assembly of FIG. 9.

FIG. 12 is a perspective view of the hook-mounting member assembly for the fishing jig assembly.

FIG. 13 is a perspective view showing the mounting of the jig head-grommet assembly to the hook-mounting member assembly to form a fishing jig.

FIGS. 14 and 15 are perspective and front views of the fishing jig of FIG. 13. FIGS. 16a and 16b are side views of a jig head-grommet assembly using small and large jig heads, respectively.

FIGS. 17 and 18 are perspective and cross-sectional side views, respectively, of an open ended jig head fishing assembly.

FIGS. 19 and 20 are perspective and cross-sectional side views of the fishing jig of FIG. 1 having a removable fishing accessory, such as a skirt, mounted to the mounting member of the fishing jig.

FIG. 21 is a perspective view of the fishing jig of FIG. 19 showing a groove for retaining the removable skirt.

FIG. 22 is a front view of the skirt of FIG. 19.

FIGS. 23-25 are perspective, front, and cross-sectional side views, respectively, of the fishing jig of FIG. 1 having a removable skirt mounted to the grommet of the fishing jig.

FIG. 26 is a side view of the fishing jig of FIG. 23 showing the groove for retaining the removable skirt.

### DETAILED DESCRIPTION

The inventor has recognized that jig heads should be made removable and replaceable to provide anglers more options in fishing but with the ability to avoid cutting fishing lines to attach a different jig, fishing accessory, or jig head. The inventor has also recognized that the current reliance on lead jig heads is not optimal to the environment, but instead is harmful to the environment, the fishing ecosystem that anglers enjoy, and the anglers themselves. To address the environmental issues concerned at least with lead jig heads, the inventor has developed lead-free or substantially lead-free jig heads. To address both of these issues, the inventor has developed a removably attachable, substantially lead-free jig head or jig attachment. The fishing jig may be broadly termed a modular fishing hook accessory mounting system that is used to removably mount a fishing accessory to a hook. The fishing accessory may be, for example, a jig head. The jig head, specifically, or fishing accessory, generally, may be removably mounted to the modular mounting member by using a recess formed within the jig head for slidably receiving at least a portion of a retaining member for retaining the retaining member and fishing accessory to the mounting member. The retaining member may be, for example, a grommet that is positioned within the jig head and has a portion that interacts with the modular mounting member to retain the grommet to the modular mounting member. Additional fishing accessories can be attached to the modular mounting member along with the fishing jig. Such additional fishing accessories include those known in the art, including skirts, rattlers, weed guards, stinger hooks, flashers, spoons and other items. A more detailed explanation is provided below.

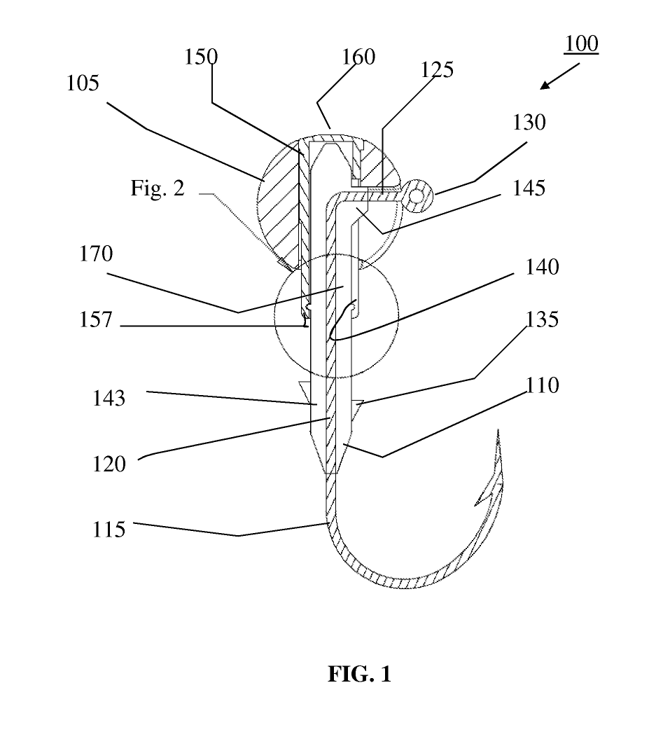

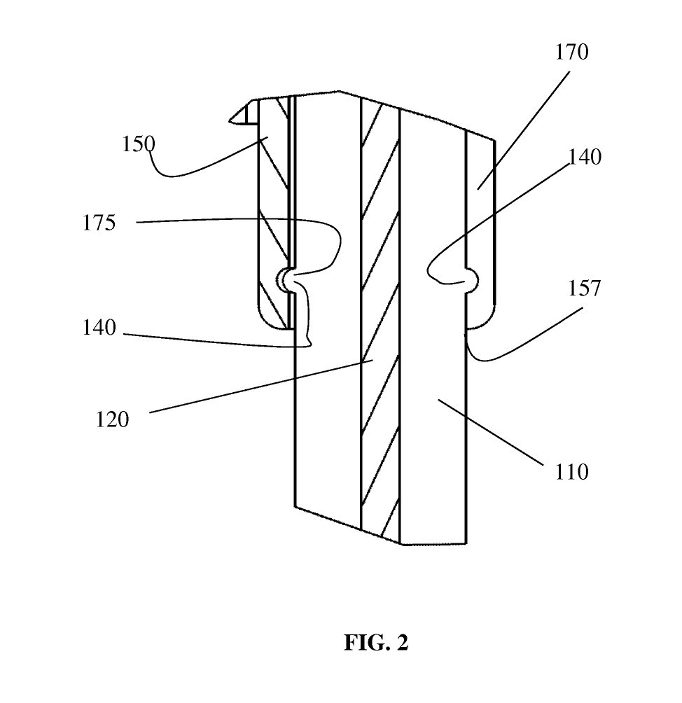

Referring to FIGS. 1 and 2, a fishing jig 100 includes a first fishing accessory, such as a jig head 105; a mounting member 110; and a hook 115. The hook 115 includes a shank 120, an eye shank 125 and an eye 130. The mounting member 110 includes a pair of barbs 135 extending from an outer surface of the mounting member for mounting a skirt (not shown) to the fishing jig and a circumferential ridge or groove 140 used in mounting the jig head 105 to the mounting member. The mounting member is, for example, plastic that is injection molded around the hook or is a separate piece that is mounted to the hook, for example by snapping or adhering two halves together around the hook to form a hook-mounting member assembly 143. The mounting member 110 also includes a ledge 145 that extends from one part of the circumference of the mounting member. The ledge 145 encloses a portion, or all, of the eye shank 125. The ledge 145 is useful in keeping the hook 115 positioned securely within the mounting member.

The jig head 105 includes a retaining member, such as a grommet 150, positioned within a channel 155 of the jig head. The retaining member is configured to be attached to the jig head, to be separate from the mounting member, and to have means to retain the jig head to the mounting member. As can be understood, numerous means can be configured to retain the grommet to the mounting member and are intended to be covered beyond those described herein.

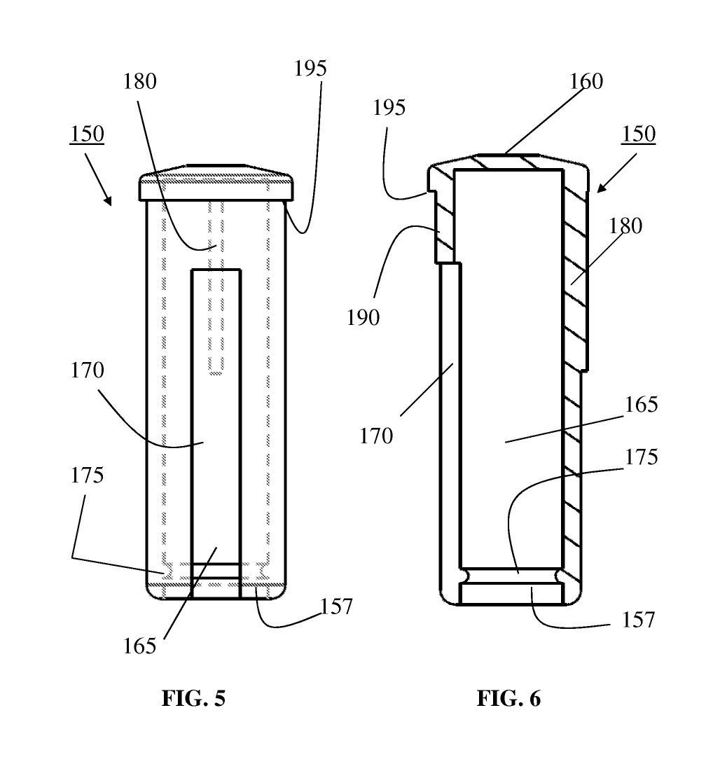

As further seen in FIGS. 2-6, the grommet has an open end 157 that is inserted over the mounting member 110 and a closed end 160 that is approximately flush with the surface of the jig head 105. The grommet includes a channel 165 passing between the open end 157 and the closed end 160. The grommet also has a slot 170 that opens from the outside of the length of the grommet into the channel 165 of the grommet. The slot 170 permits the grommet to be slidably mounted to the mounting member 110 and be positioned such that the ledge 145 and eye shank 125 are positioned at least in part within the grommet.

The grommet 150 also includes a circumferential groove or ridge 175 that extends into the channel 165 from the inner surface of the grommet. Although the ridge 175 can be positioned anywhere along the length of the grommet, FIG. 2 illustrates the ridge being in proximity of the open end 157 of the channel 165 and receiving the circumferential groove 140. This interaction between the ridge 175 and the circumferential groove 140 removably retains the grommet to the mounting member 110. Because the jig head 105 is positioned around the grommet, the jig head 105 thereby is retained to the mounting member 110 and hook 115.

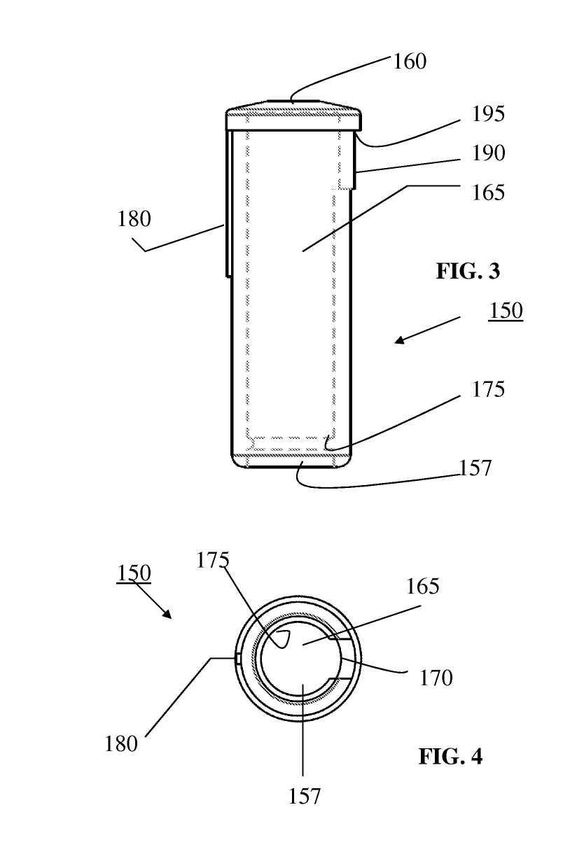

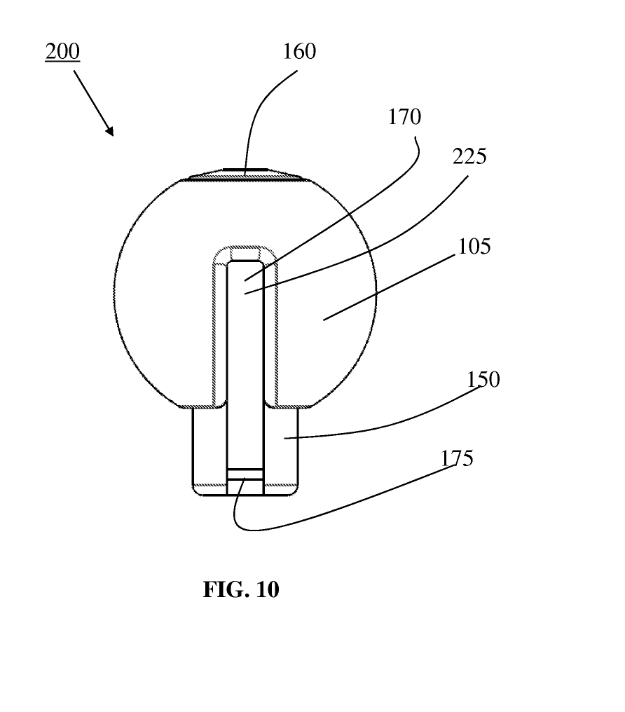

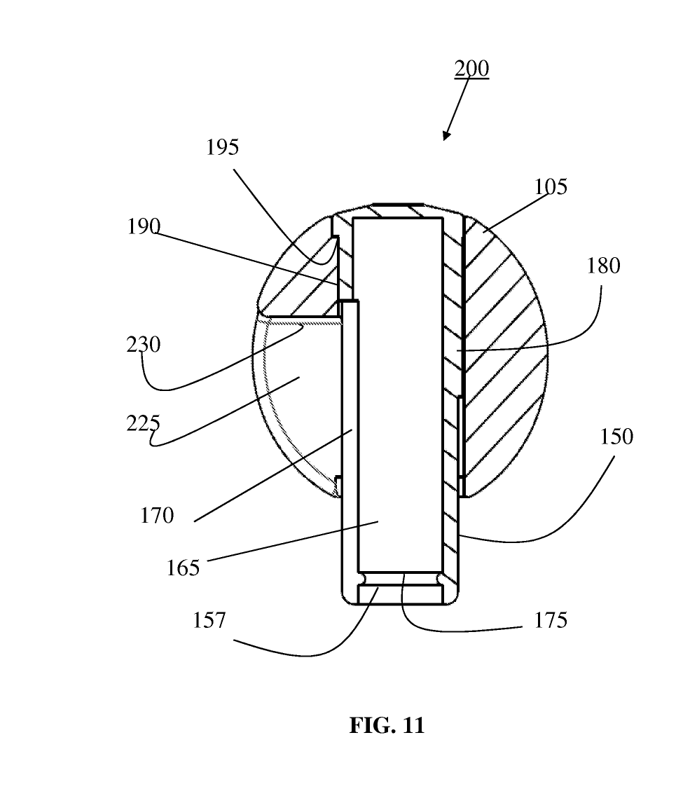

It should be noted that the combination of the ridge or groove 140 on the mounting member and the groove or ridge 175 in the grommet forms a retaining means that retains the grommet to the mounting member. FIGS. 1 and 2 illustrate the retaining means being formed by the interaction between the ridge 140 on the mounting member and the grooves 175 in the grommet. In contrast, FIGS. 3-11 illustrate the retaining means being formed by the interaction between the groove 140 being positioned in the mounting member and the ridge 175 being positioned in the grommet. It should also be understood that other configurations of the retaining means may be used. For example, the retaining means can be formed by a combination of grooves and ridges on the mounting member and a combination of grooves and ridges on the grommet. Because the grommet will only mate with the mounting member in one orientation, the various grooves and ridges will be aligned to properly mate. In addition to the grooves and ridges extending around the respective circumference of their retaining means, the grooves and ridges can be one or more discrete grooves or ridges rather than a single groove and a single ridge.

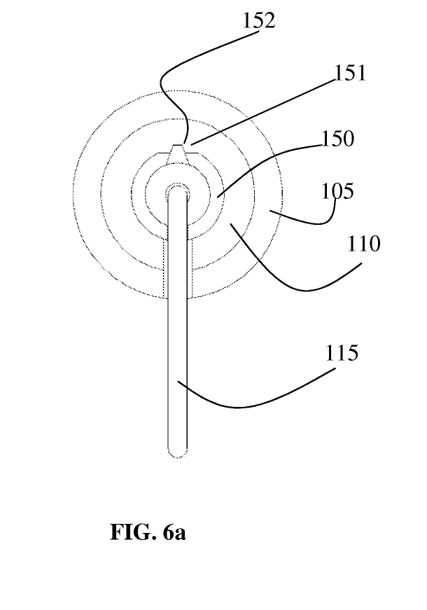

Referring also to FIG. 6A, which is a bottom view of the fishing jig, the grommet 150 can be modified to have an alignment edge 151 that mates with an alignment edge 152 of the jig head. This configuration ensures that the grommet is aligned properly with the jig head and prevents the jig head from rotating about the grommet. In FIG. 6A, the grommet has a flattened surface as the alignment edge 151 which causes the grommet to have a D-shaped appearance.

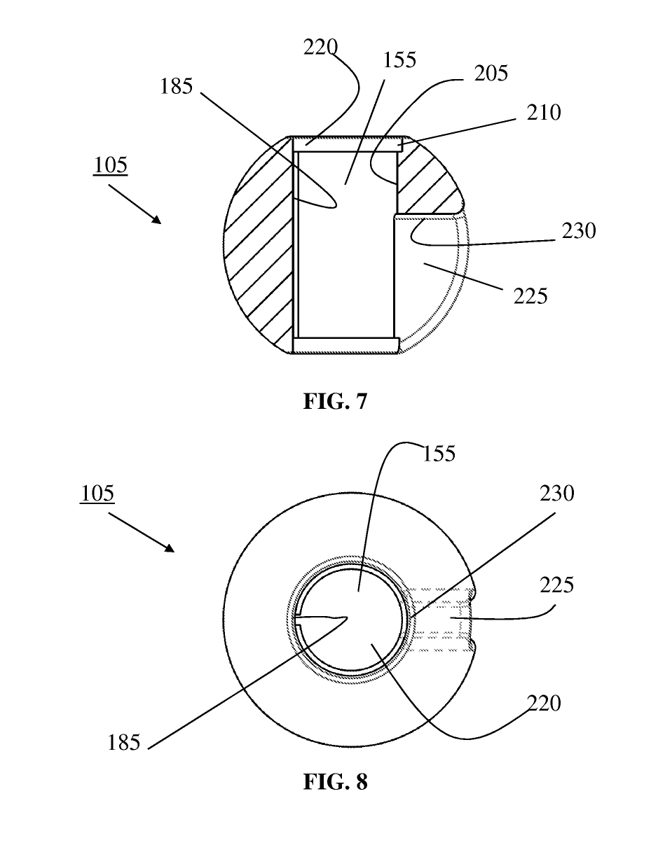

Referring also to FIGS. 7-11, the grommet 150 and jig head 105 are designed to be assembled in a quick, reliable, and simple manner. The grommet 150 includes a longitudinal ridge 180 that extends from the outer surface of the grommet and runs at least a portion of the length of the grommet. The jig head 105 includes a longitudinal groove 185 that is configured to align the jig head to the grommet when the ridge 180 is slidably mated with the groove 185. A pair of shoulders 190, 195 extend from the outer surface of the grommet and mate with grooves 205, 210, respectively, that extend into the jig head from the surface of the channel 155. By mating the ridge 180 into the groove 185, the shoulder 190 resides within the groove 205 and the shoulder 195 resides within the groove 210. The grooves 205, 210 do not extend the entire length of the channel 155 but instead terminate such that the grommet cannot be passed through the entire length of the channel 155 between the first end 215 and the second end 220. In this manner the grommet can be removed from the jig head only by pulling it out from the opening 220 into the jig head in which it was inserted. As explained in more detail below, this configuration also advantageously keeps the grommet firmly seated within the jig head when pull the jig head off of the mounting member during jig head exchange.

The jig head 105 also includes a slot 225 into the channel 155. The slot 225 passes between the outer surface of the jig head and the channel, but does not extend the full length of the channel. Instead, the slot 225 terminates in a shoulder 230 such that the eye shank 125 of the hook will be in contact with the shoulder 230 when the jig head 105 is mounted to the mounting member 110, as best illustrated in FIG. 1.

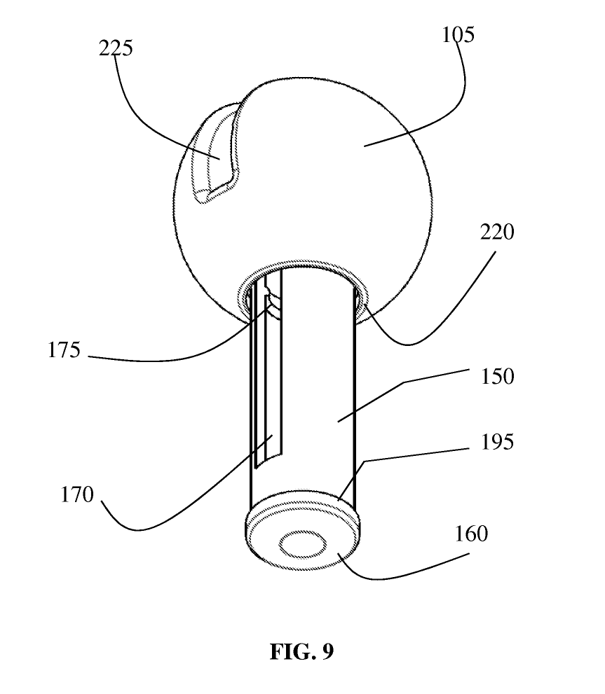

FIGS. 9-11 illustrate the insertion of the grommet 150 into the jig head 105 to form a jig head-grommet assembly 200. The end of the grommet 150 defined by the opening 157 is inserted first into the opening 220 of the jig head. To properly align the slot 170 in the grommet with the slot 225 in the jig head, the grommet 150 is inserted such that the ridge 180 is inserted within the groove 185. The presence of the ridge 180 and the tight tolerances between the outer diameter of the grommet and the inner diameter of the channel 155 prevent the grommet from being misaligned within the jig head 105.

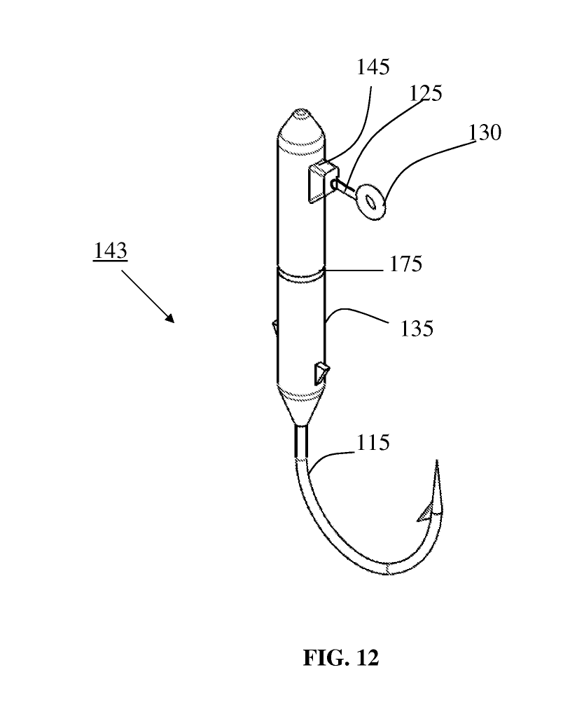

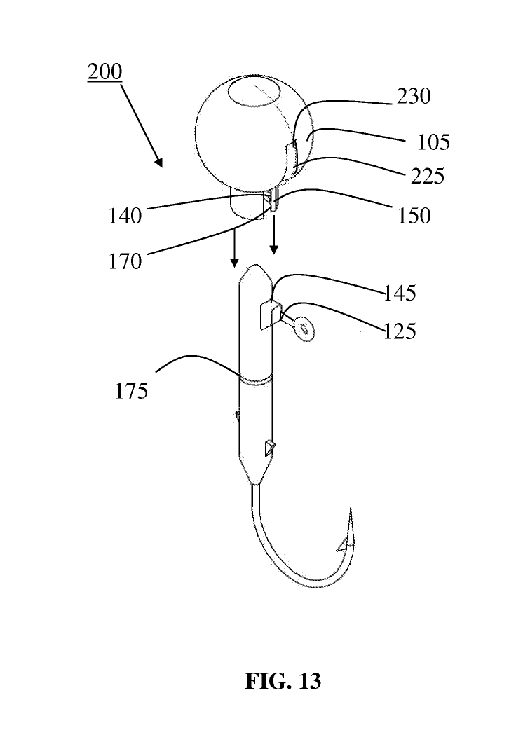

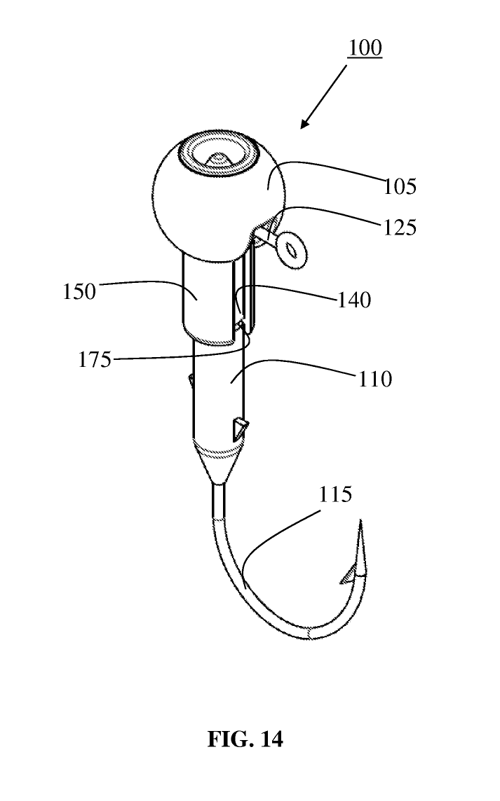

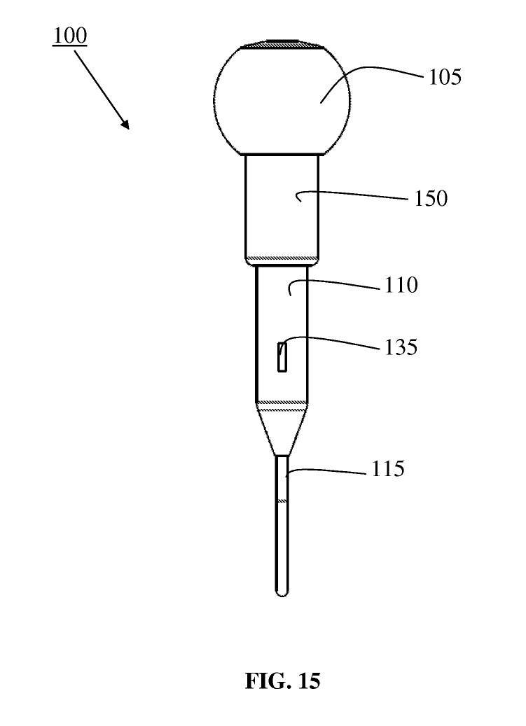

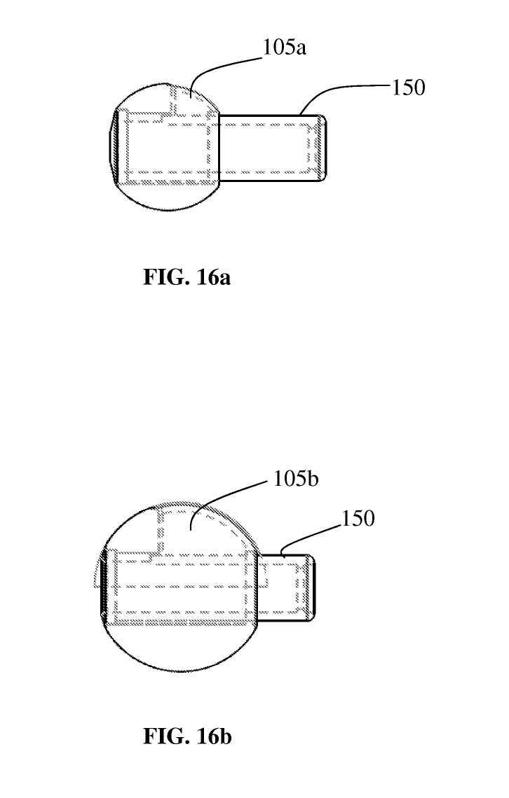

FIGS. 12-15 illustrate the mounting of the jig head-grommet assembly 200 to the hook-mounting member assembly 143. FIG. 12 illustrates the hook-mounting member assembly 143 prior to mounting of the jig head-grommet assembly. FIG. 13 illustrates the jig head-grommet assembly 200 being advanced towards the hook-mounting member assembly 143. The slots 170, 225 are aligned to pass around the ledge 145 and eye shank 125. As illustrated in FIGS. 14 and 15, the jig head-grommet assembly 200 is further advanced until the ridge 140 slides into the groove 175 and the shoulder 230 rests against the ledge 145.

To remove the jig head-grommet assembly 200 from the mounting member 110, the angler slightly expands the opening 157 in the grommet to pull the ridge 140 out of the groove 175 and pulls on the jig head 105 away from the mounting member 110. Depending upon the configuration of the ridge 140 and groove 175 that forms the retaining means, the angler would either need to expand the opening 157 slightly or otherwise would need to merely exert a pulling force on the jig head 105 to pull the ridge 140 our of the groove 175.

With the jig head-grommet assembly 200 removed, the angler than can mount a different jig head-grommet assembly, such as of a different size, weight, color, shape, etc. For example, FIGS. 16a and 16b illustrate two different jig head assemblies 200 that differ in the size of the jig head 105a and 105b. By carefully designing the jig head 105, multiple jig heads can be used with a single mounting member 100. This conveniently reduces the number of parts for both the angler and the manufacturer to need to purchase and keep on hand for fishing and manufacturing, respectively.

As should be evident, the replaceable jig head assembly permits the angler to conveniently remove and replace the jig head assembly without cutting the fishing line. The eye 130 of the hook does not pass through the jig head 105 but instead extends outwardly away from the side of the jig head such a fishing line does not need to pass through the channel 155 in the jig head.

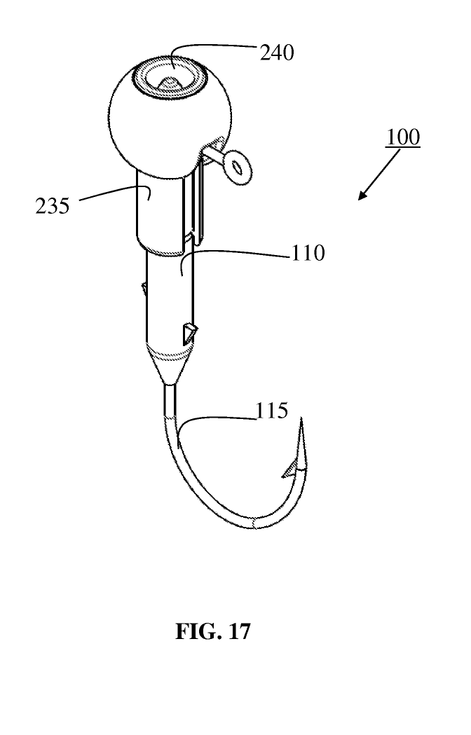

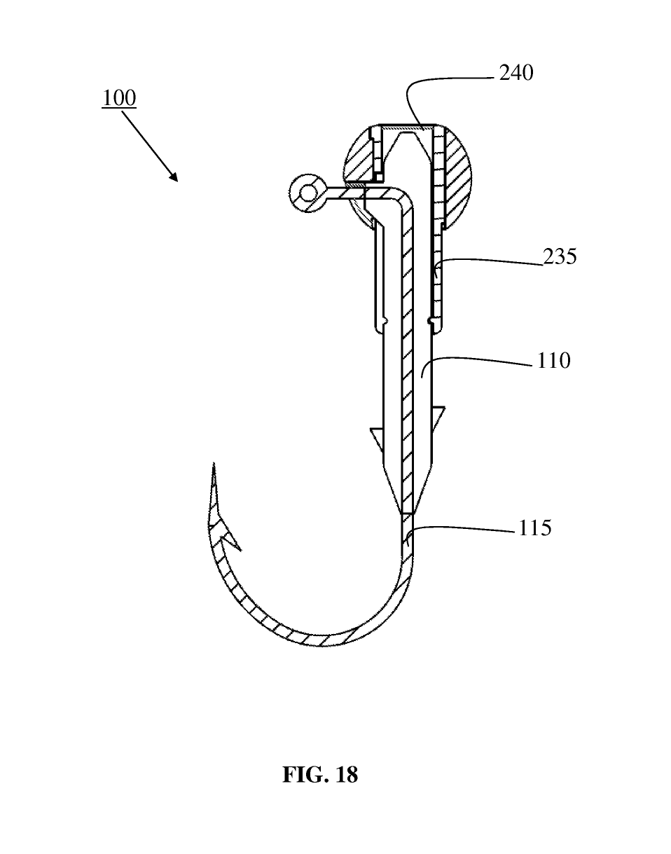

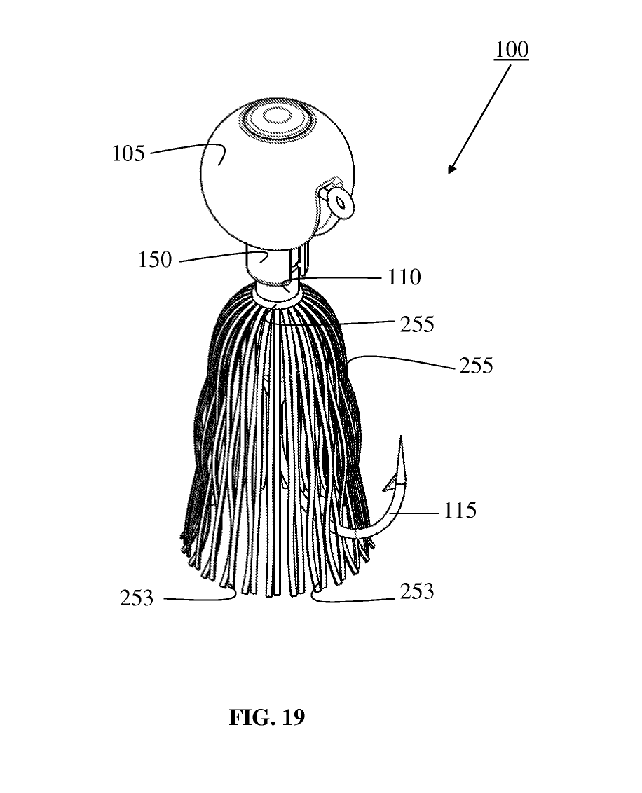

FIGS. 1-16 illustrate the fishing jig 100 as having the grommet 150 with a closed end 160. This can be advantageous because the configuration will keep debris out of the channel 155. FIGS. 17 and 18 illustrate the fishing jig 100 as having a grommet 235 with an open end 240. The open end 240 thereby permits the channel 165 to pass between opening 157 and the open end 240.

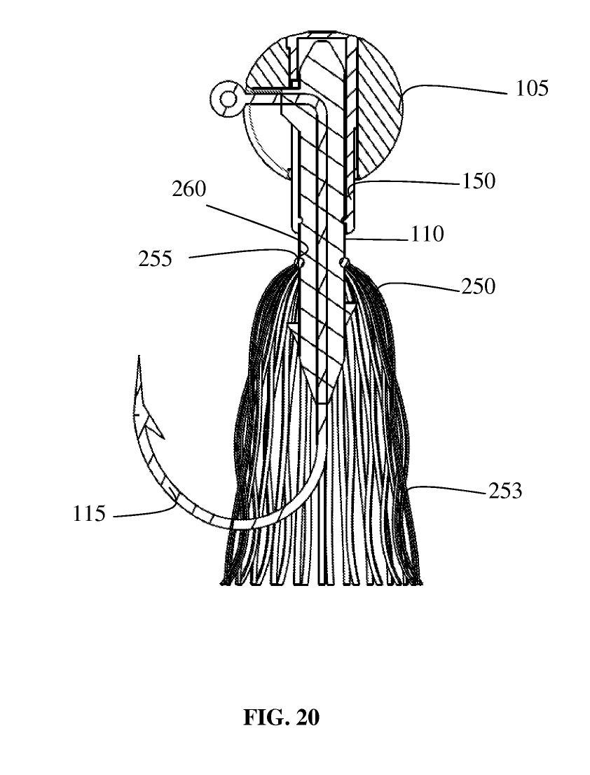

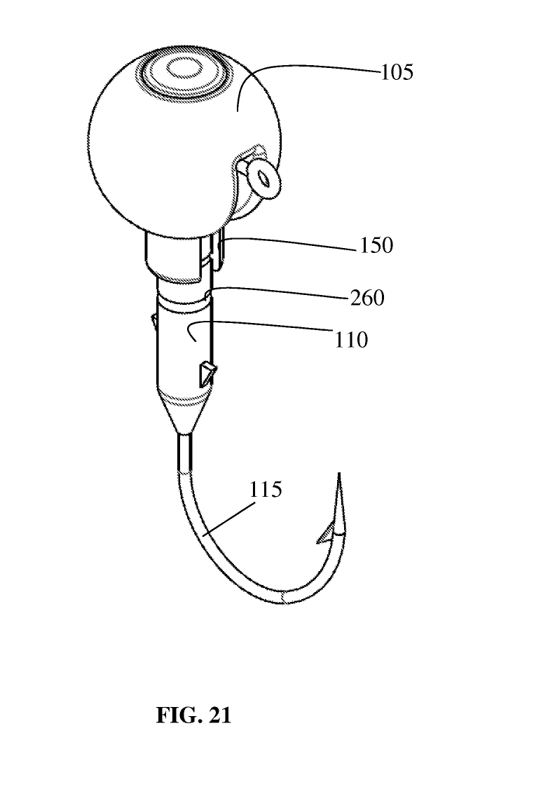

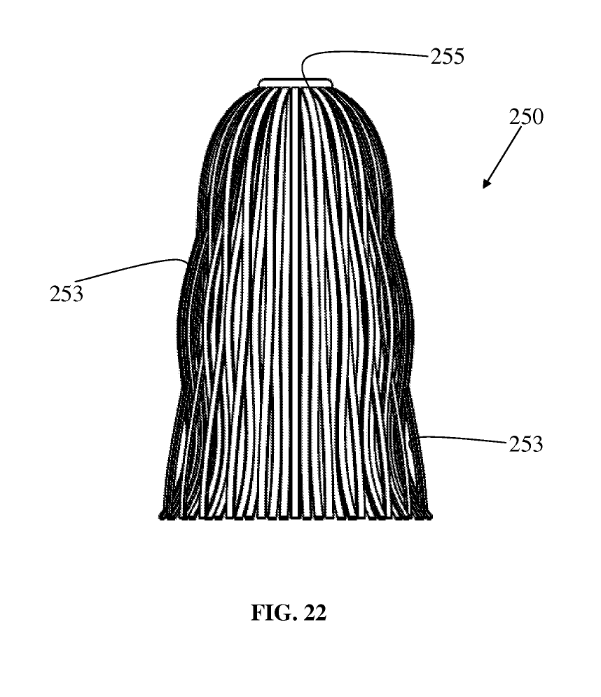

FIGS. 19-22 illustrate a modification of the mounting member 110 to permit removable attachment of a second fishing accessory, such as a skirt 250, to the mounting member. The skirt 250 includes multiple strands 253 that extend from a ring 255. The ring 255 is typically made of an elastic material, such as metal or plastic, that can be snapped in place within a groove 260 that passes around the circumference of the mounting member 110. The ring can be configured to be incomplete and encompass only a portion of the circumference of the groove 260. In this configuration, an opening in the ring is expanded, the ring placed around the mounting member, and then slipped into the groove 260. This configuration serves as a retaining means to hold the skirt 250 to the mounting member 110.

Although the ring can be of an incomplete circumference, as described above, the ring can also be an elastic material, such as an elastic band, to which the strands 253 are attached. In use, the elastic band is passed over the tip of the hook, advanced onto the mounting member 110 and seated in the groove 260. Whether the ring is of an incomplete circumference or formed from an elastic band, the skirt 250 can be removed and replaced with a different skirt, such as of a different color, thickness or length, as known in the art.

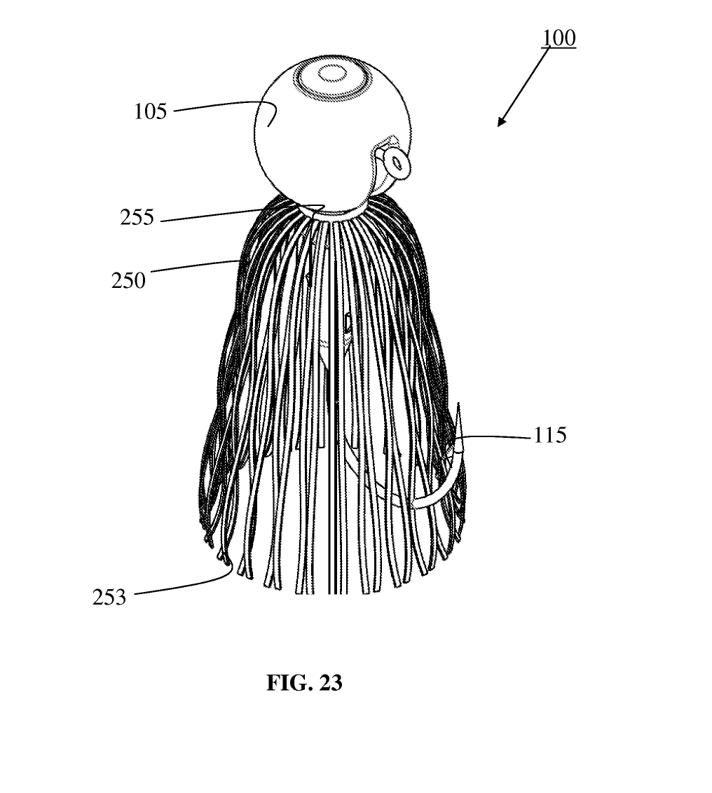

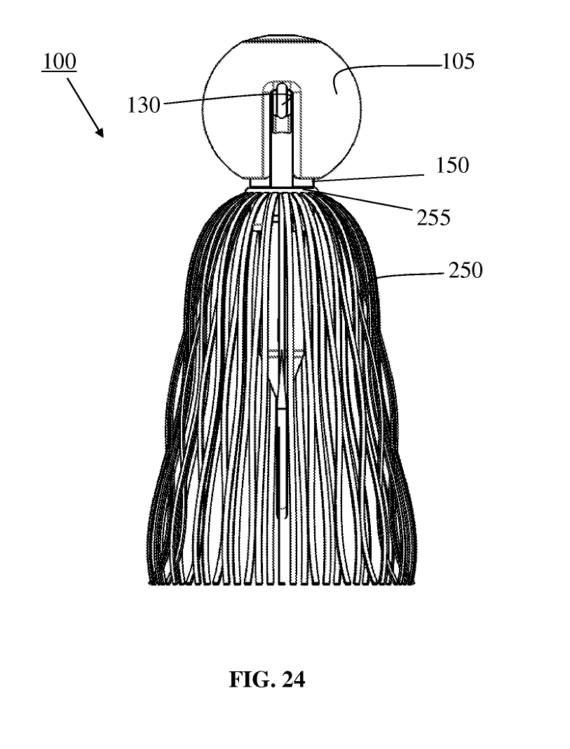

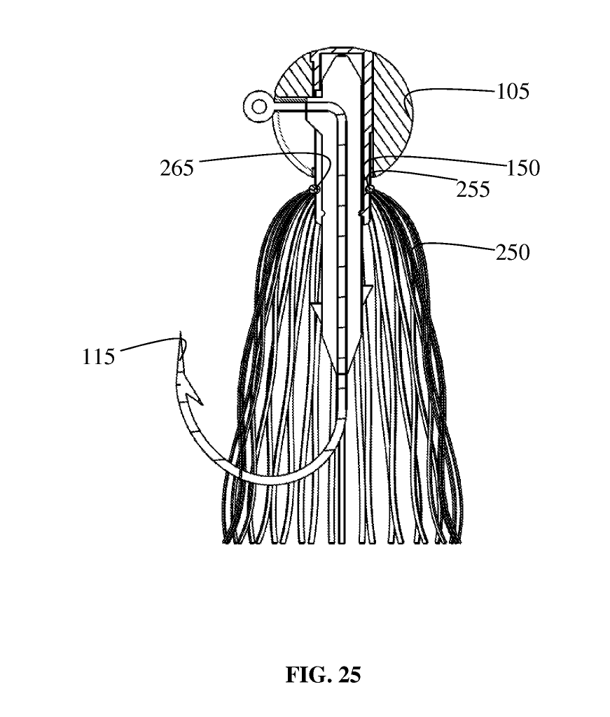

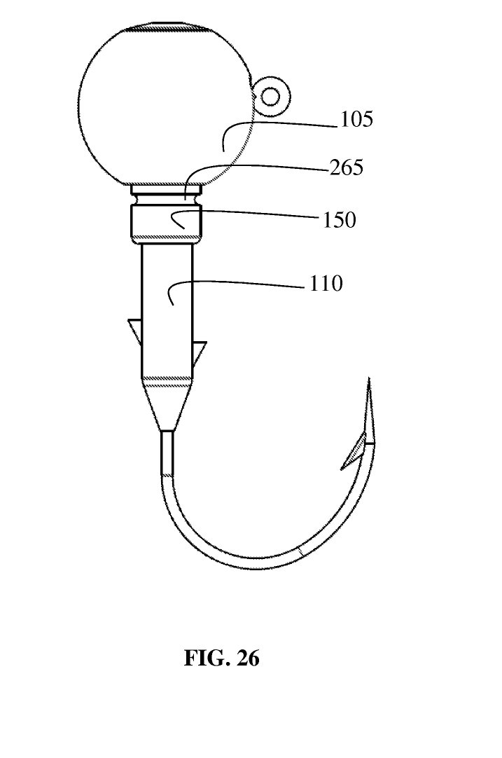

In addition, referring to FIGS. 23-26, the fishing jig can be modified such that a groove 265 is formed on the grommet 150 in a position adjacent to the jig head. The elastic member 255 is positioned over the hook, mounting member and then over the grommet and into the groove 265. Placing the elastic member in the groove 265 serves an additional purpose of reinforcing the seating of the ridge 140 into the groove 175. In this manner, the elastic member can be used to retain, in part or in whole, the jig head-grommet assembly to the hook-mounting member assembly.

It should be understood that a groove to retain the fishing accessory, such as the skirt, to the fishing jig can be positioned anywhere along the length of the mounting member or grommet. In addition, the retaining groove can be positioned around the circumference of the jig head on either side of the eye shank 125. Further, there can be multiple grooves on multiple members (e.g., mounting member, groove, jig head, etc.) to mount multiple fishing accessories.

The fishing jigs described herein can be formed in a number of manners. For example, the mounting member can be plastic that is injection molded in place around the fishing hook or separately molded and then mounted to the hook. The grommet can be of an extruded or injection molded plastic or a combination of the two processes with additional manufacturing steps as are known in the art. The jig head may be formed of most metals, including steel, tungsten, brass, nickel, copper, lead, tin, aluminum, alloys, etc. A steel jig head can be formed in a process that involves a granulated powdered metal. In general, the powdered metal is granulated, pressed and sintered. An advantage of this process is that there is no need for machining other than an optional step to ensure the surface of the jig head is smooth and without burrs or the like. The density of the metal used can be varied to provide a jig head of a variety of weights and sizes.

In addition, the jig head can be made of a lighter, buoyant material to make a replaceable, floating jig head. Such materials include Styrofoam, balsam wood, a hollow molded plastic, etc. Such a floating jig head would include the grommet used with the metal jig head.

While several particular forms of the invention have been illustrated and described, it will be apparent that various modifications and combinations of the invention detailed in the text and drawings can be made without departing from the spirit and scope of the invention. For example, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited, except as by the appended claims.

What is claimed is:

1. A modular fishing hook accessory mounting system for removably mounting a fishing accessory on a hook, the system comprising:
a hook having a shank portion and an eye shank portion, the eye shank portion being located at one end of the shank portion;
a modular mounting member mounted on the hook for removably receiving a fishing accessory; and
a fishing accessory removably mounted on the modular mounting member, the fishing accessory having a recess formed therein for slidably receiving at least a portion of a retaining member for retaining the retaining member and fishing accessory to the mounting member.

2. The modular fishing hook accessory mounting system of claim 1, wherein the fishing accessory comprises a jig head.

3. The modular fishing hook accessory mounting system of claim 2, wherein the jig head is substantially lead-free.

4. The modular fishing hook accessory mounting system of claim 2, wherein the jig head is lead-free.

5. The modular fishing hook accessory mounting system of claim 2, wherein the jig head comprises steel.

6. The modular fishing hook accessory mounting system of claim 5, wherein the jig head comprises a sintered steel.

7. The modular fishing hook accessory mounting system of claim 2, wherein the jig head comprises one or more of tungsten, nickel, brass, copper, lead, tin, iron, aluminum, alloys and a composite of one or more metals.

8. The modular fishing hook assembly mounting system of claim 1, wherein the retaining member includes a retaining portion for mating with a retaining portion of the mounting member to form a retaining system for removably securing the retaining member to the mounting member.

9. The modular fishing hook accessory mounting system of claim 8, wherein the retaining system comprises at least one ridge extending from the retaining member and at least one groove extending into the mounting member for receiving the ridge.

10. The modular fishing hook accessory mounting system of claim 8, wherein the retaining system comprises at least one groove extending into the retaining member and at least one ridge extending from the mounting member for being received in the groove.

11. The modular fishing hook accessory mounting system of claim 1, wherein the shank portion and the eye shank portion of the hook meet at a juncture, the modular mounting member being located at the juncture of the hook.

12. The modular fishing hook accessory mounting system of claim 1, wherein the retaining member comprises a grommet having a channel through at least a portion of its length.

13. The modular fishing hook accessory mounting system of claim 1, wherein the retaining member comprises a grommet having at least one aligning portion configured to align the grommet with the fishing accessory.

14. The modular fishing hook accessory mounting system of claim 13, wherein the grommet comprises a longitudinal slot for receiving the eye shank portion.

15. The modular fishing hook accessory mounting system of claim 1, further comprising a retaining system for retaining a second fishing accessory to the modular fishing hook accessory mounting system.

16. The modular fishing hook accessory mounting system of claim 15, wherein the retaining system comprises an elastic ring member on the second fishing accessory and a groove or ridge for mating with the elastic ring member.

17. The modular fishing hook accessory mounting system of claim 16, wherein the groove or ridge is placed on the mounting member, the retaining member, and/or the fishing accessory.

18. A lead-free fishing jig for removably mounting a jig head on a hook, the system comprising:
a hook having a shank portion and an eye shank portion, the eye shank portion being located at one end of the shank portion;
a modular mounting member mounted on the hook for removably receiving the jig head; and
a jig head removably mounted on the modular mounting member.

19. The lead-free fishing jig of claim 18, wherein the jig head has a recess formed therein for slidably receiving at least a portion of a retaining member for retaining the retaining member and jig head to the mounting member.

20. The lead-free fishing jig of claim 18, wherein the jig head comprises one or more of steel, tungsten, nickel, brass, lead, and a composite of one or more metals.

21. The lead-free fishing jig of claim 20, wherein the jig head comprises steel.

22. The lead-free fishing jig of claim 20, wherein the jig head comprise a sintered steel.

23. A method of forming a jig head for a fishing jig, the method comprising providing a powdered steel, pressing the steel, and sintering the steel.

24. The method of claim 23, wherein the steel is substantially free of lead.

25. A removable jig head comprising:
a jig head having a channel there through; and
a retaining member for being slidably received within the channel.

26. The removable jig head of claim 25, wherein the retaining member comprises a grommet.
